(19) United States
(12) Patent Application Publication
(10) Pub. No.: US 2004/0013835 A1
(43) Pub. Date: Jan. 22, 2004

(54) Multilayer plastic tube for fluids used in motor vehicles

(76) Inventor: Guillaume Miguel, Concues En Ouche (FR)

Correspondence Address: YOUNG & THOMPSON, 745 SOUTH 23RD STREET 2ND FLOOR, ARLINGTON, VA, 22202

(21) Appl. No.: 10/333,062

(22) PCT Filed: Aug. 3, 2001
(86) PCT No.: PCT/FR01/02539

(30) Foreign Application Priority Data
Aug. 11, 2000 (FR) 00/10588

(51) Int. Cl. B32B 1/08

(52) U.S. Cl. 428/36.91

(57) ABSTRACT

A hose (10) made of plastics material, for conveying a motor vehicle fluid such as fuel, the hose possessing a multilayer structure comprising, from the inside to the outside:

an inner layer (11) made of polyamide;

a connecting layer (12) formed of a copolymer of polyethylene and maleic anhydride;

a layer (13) of high density polyethylene (HDPE); and

a layer of polyester-ether copolymer having elastomeric properties.

The present invention provides a multilayer hose made of plastics material, for conveying fluids, mainly fuel, in a motor vehicle.

Replacing metal pipework in motor vehicles with pipework made of plastics material has become commonplace for the obvious reasons of reducing weight leading to a reduction in fuel consumption and consequently a reduction in atmospheric pollution.

The thermoplastic materials currently on the market offer a wide range of properties, but no material has all the properties required for conveying a fuel. For example, some have excellent barrier properties but poor mechanical or flame-resistant properties. Alternatively, others are mechanically satisfactory but tend either to dissolve in the fuel or to be permeable to said fuel, thereby causing further atmospheric pollution. In addition, others do not lend themselves to the forming operations to which a duct must be subjected in order to be used in a motor vehicle.

Furthermore, with regard to pollution and safety in motor vehicles, a battery of regulations have been put into place which set stringent objectives to be achieved in coming years, and which are thus stimulating intense research activity, in particular in the field of fuel pipes.

The current tendency is thus to make multilayer pipes of thermoplastic material in order to accumulate the positive properties of each material so as to obtain an acceptable compromise that is capable of satisfying the standards that are currently or soon to be in force. An economic requirement, namely to obtain this compromise at the best cost, is in addition to such technical requirements.

In this perspective, the invention provides a multilayer pipe made of thermoplastic material comprising, from the inside to the outside, the following composition:

a layer of polyamide;

a layer of a copolymer of polyethylene and maleic anhydride;

a layer of high density polyethylene (HDPE); and

a layer of elastomer material having a polyester-ether base.

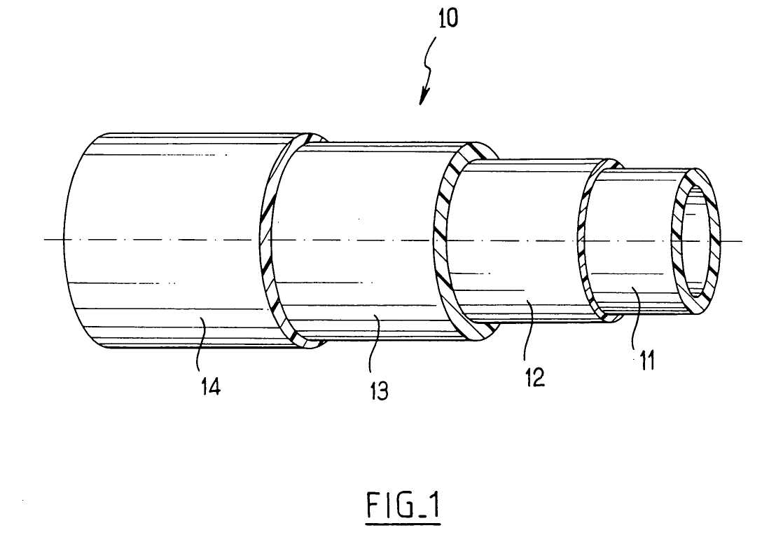

Other characteristics and advantages of the invention appear more clearly from the following description and from the accompanying drawing, relating to a particular embodiment, with reference to FIG. 1 which shows, in stepped section, a multilayer hose of the invention.

The multilayer hose, referenced 10, comprises four successive layers, respectively referenced 11, 12, 13, and 14 going from the inside to the outside of said hose.

The inner layer 11 made of polyamide presents good compatibility with hydrocarbons (absence of chemical reaction or of dissolution), and further constitutes a good-quality barrier against the compounds contained in a fuel. and it also forms mechanical reinforcement for the hose. PA3 is preferably selected.

The layer 12 of polyethylene and maleic anhydride copolymer is mainly used for its bonding properties enabling the polyamide to bond intimately with the layer of high-density polyethylene (HDPE) which forms the third layer 13.

The third layer 13 provides the tube 10 with the property of being an effective barrier against the alcohols contained in fuel, while also reinforcing the strength of said tube.

Finally, the last layer, the outer layer referenced 14, is constituted by polyester-ether copolymer having elastomeric properties. This layer protects the tube 10 against the fluids with which it may occasionally come into contact (oil, water containing various salts, in particular in winter, . . . ), and it provides protection against impacts, and it also withstands well the bending stresses and the flexing-fatigue stresses to which the tube may be subjected, this being achieved by means of its elastomer nature. Furthermore, this last layer withstands cuts and abrasion well.

The sum of these properties enables a multilayer hose to be made having a wall that is relatively thin, i.e. depending on its diameter, a total thickness lying in the range 0.6 millimeters (mm) to 1.5 mm, with said thickness being distributed over the individual layers as follows: 0.2 mm to 0.5 mm for the inner layer 11; 0.1 mm for the connecting layer 12; 0.2 mm to 0.5 mm for the HDPE layer 13; and finally 0.1 mm to 0.4 mm for the outer layer 14.

One possible material for the outer layer 14 is put on the market under the commercial name ARNITEL (registered trademark of the supplier DMS).

A multilayer hose is thus obtained satisfying the EURO 2000 rules with a minimum material weight.

Furthermore, the materials used are relatively inexpensive, thereby enabling the tube to be manufactured at low cost.

Finally, the materials lend themselves to being manufactured either by coextruding the four layers 11, 12, 13, and 14, or by coextruding the three inner layers 11, 12, and 13, and subsequently applying an elastomer coating on the coextruded layers.

1/ A hose (10) made of plastics material, for conveying a motor vehicle fluid such as fuel, the hose being characterized in that it possesses a multilayer structure comprising, from the inside to the outside:
an inner layer (11) made of polyamide;
a connecting layer (12) formed of a copolymer of polyethylene and maleic anhydride;
a layer (13) of high density polyethylene (HDPE); and
an outer layer (14) of polyester-ether copolymer having elastomeric properties.

2/ A hose according to claim 1, characterized in that it has a total wall thickness lying in the range 0.6 mm to 1.5 mm, distributed as follows:
the inner layer (11) lies in the range 0.2 mm to 0.5 mm;
the connecting layer (12) is 0.1 mm;
the layer (13) of high density polyethylene lies in the range 0.2 mm to 0.5 mm; and
the outer layer (14) lies in the range 0.1 mm to 0.4 mm.

3. A hose according to any preceding claim, characterized in that the polyamide constituting the inner layer (11) is a PA6, and in that the polyester-ether constituting the outer layer (14) is a product put on the market under the registered trademark ARNITEL.

5. A hose according to claim 4, having a total wall thickness lying in the range 0.6 mm to 1.5 mm, distributed as follows:
the inner layer (11) lies in the range 0.2 mm to 0.5 mm;
the connecting layer (12) is 0.1 mm;
the layer (13) of high density polyethylene lies in the range 0.2 mm to 0.5 mm; and
the outer layer (14) lies in the range 0.1 mm to 0.4 mm.

6. A hose according to claim 4, wherein the polyamide constituting the inner layer (11) is a PA6, and in that the polyester-ether constituting the outer layer (14) is a product put on the market under the registered trademark ARNITEL.
